(19) United States
(12) Patent Application Publication
(10) Pub. No.: US 2026/0334593 A1
(43) Pub. Date: Oct. 29, 2026

(54) AEROSOL PROVISION SYSTEM

(71) Applicant: Nicoventures Trading Limited, London (GB)

(72) Inventors: Deng DAI, Shenzhen (CN); Hong Meng TIAN, Shenzen (CN)

(21) Appl. No.: 19/491,078

(22) PCT Filed: Jun. 6, 2024
(86) PCT No.: PCT/EP2024/065666

§ 371 Date: Dec. 8, 2025

(30) Foreign Application Priority Data
Jun. 9, 2023 (CN) 2023106852254
Jun. 30, 2023 (GB) 2310050.6

(51) Int. Cl. A24F 40/95; A24F 40/10; A24F 40/20

(52) U.S. Cl. CPC A24F 40/95; A24F 40/10; A24F 40/20

(57) ABSTRACT

aerosol provision system comprises an aerosol provision device and a charging unit charging or powering the device. The device and the charging unit are connectable by attachment mechanism comprising a first engagement member, which includes at least wire spring, and a second engagement member. The device comprises one of the first second engagement members, and the charging unit comprises the other. Movement the first engagement member in a direction perpendicular to the longitudinal axis of the device when the device is inserted into a cavity in the charging unit enables the first engagement member to snap into engagement with the second engagement member, and disengage when the device is pulled out of the cavity.

### CROSS-REFERENCE TO RELATED APPLICATIONS

This present application is a National Phase entry of PCT Application No. PCT/EP2024/065666, filed Jun. 6, 2024, which claims priority from Chinese Application No. 2023106852254, filed Jun. 9, 2023, and which claims priority from Great Britain Application No. 2310050.6, filed Jun. 30, 2023, each of which are fully incorporated herein by reference in their entireties.

### TECHNICAL FIELD

The present invention relates to an aerosol provision system, and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium. Separately, induction heating systems are known to be used as heaters.

### SUMMARY

According to an aspect there is provided an aerosol provision system comprising: an aerosol provision device; and a charging unit for charging or powering the aerosol provision device, the charging unit having a cavity for receiving the aerosol provision device. The aerosol provision device and the charging unit are connectable by an attachment mechanism comprising: a first engagement member comprising at least one wire spring; and a second engagement member; wherein the aerosol provision device comprises one of the first and second engagement members, and the charging unit comprises the other of the first and second engagement members; and wherein the first engagement member is configured to snap into engagement with the second engagement member when the aerosol provision device is inserted into the cavity, and disengage with the second engagement member when the device is pulled out of the cavity, enabled by movement of the first engagement member in a direction perpendicular to a longitudinal axis of the device.

The first engagement member may be provided on the charging unit and the second engagement member may be provided on the aerosol provision device.

The first engagement member may be provided on the aerosol provision device and the second engagement member may be provided on the charging unit.

The second engagement member may comprise one or more grooves or recesses.

The first engagement member may comprise a single wire spring. The second engagement member may comprise two or more grooves or recesses. The single wire spring may be configured to engage with two or more grooves or recesses

The first engagement member may comprise two or more wire springs. The two or more springs may be configured to engage with a single groove or recess. The two or more springs may be configured to engage with a single groove or recess provided on a single lug. The second engagement member may comprise corresponding grooves or recesses, and each of the two or more springs may be configured to engage with a corresponding grooves or recesses.

The wire spring(s) may be made from any suitable material having the ability to flex when a force is applied and return to its original shape. The wire spring(s) may be made from a metallic material, such as, but not limited to stainless steel, high carbon steel, nickel-based alloy, chromium-based alloy. The wire spring(s) may be made from a plastic material such as, but not limited to: fibre-reinforced plastic, engineered thermoplastic, eg polypropylene, polycarbonate, polyvinyl chloride, ABS, polystyrene, acetal, PEEK material (polyetheretherketone) and nylon. The wire spring(s) may be provided with a sleeve, extending along at least part of the or each spring.

The charging unit may comprise one or more lugs at a distal end of the cavity. The aerosol provision device may comprise one or more corresponding accommodating recesses for receiving the one or more lugs when the aerosol provision device is received in the cavity.

The second engagement member may be provided on the one or more lugs.

The second engagement member may be provided on an inner surface of the charging unit cavity. The second engagement member may comprise one or more grooves or recesses provided on an inner surface of the charging unit cavity.

The first engagement member may be configured to snap into engagement with the second engagement member by moving in a direction towards a central axis of the cavity.

The first engagement member may be configured to snap into engagement with the second engagement member in a direction away from a central axis of the cavity.

The first engagement member may be configured to snap into engagement with the second engagement member in a direction parallel to a central axis of the cavity.

The charging unit may comprise one or more first electrical connectors for connecting to the aerosol provision device. The aerosol provision device may further comprise one or more second, corresponding electrical connectors for connecting to the charging unit. The charging unit may comprise two, three or four first electrical connectors. The aerosol provision device may comprise two three or four second electrical connectors.

The one or more first electrical connectors are provided at a distal end of the cavity of the charging unit. The one or more second electrical connectors may be provided at the distal end of the aerosol provision device.

The first and second connector(s) may be pogo-pin connectors and corresponding mating receptacles or contact plates. The first and second connector(s) may be male and female USB connectors.

The cavity of the charging unit may have a cross-sectional profile which corresponds to the profile of the aerosol provision device. The cavity of the charging unit may have a cross-sectional profile configured to permits the aerosol provision device to be inserted into the charging unit in a single orientation. An outer profile of the aerosol provision device may comprise an arcuate portion and a linear portion. The cross-sectional profile of the cavity provided in the charging unit may also comprise a similar arcuate portion and a linear portion. The cavity of the charging unit may have a length that is substantially equal to or slightly greater than the length of the aerosol provision device such that substantially the entire length of the aerosol provision device is received in the cavity of the charging unit.

The cavity may further comprise a longitudinally extending opening. A first side of the aerosol provision device may be received in the longitudinal opening provided in the charging unit.

The aerosol provision system may further comprise an aerosol generating article.

The aerosol generating article may comprise an aerosol-generating material. aerosol-generating material may be in the form of a solid, liquid or semi-solid (such as a gel). The aerosol-generating material may contain an active substance and/or flavourants.

The aerosol generating article may be a stick format. The aerosol generating article may be a rod-shaped article. The aerosol generating article may have a non-circular cross section, such as but not limited to oval, rectangular, trapezoidal. The aerosol generating article may be substantially flat.

The aerosol provision device may comprise a heating chamber, in which a heating element is provided. The heater element may comprise at least one heater coil. The heating element may comprise a single coil. The coil may have a constant pitch. The coil may have a variable pitch, wherein a central portion of the coil has less windings per unit length than the two end portions. The heating element may comprise two or more coils. The coil(s) may be helical coils.

The heating element may be a resistive heating element. The heater may be a resistive heater. The heating element may be a resistive heating element. The heating element may be a resistive heating coil.

The heating element may be an inductive heating element.

The heater may be an inductive heating heater. The heating element may be an inductive heating element. The coil may be an inductive coil.

The aerosol provision device may comprise a power source, a controller and a heating chamber, in which the aerosol generating article is removeable received. The power source may be aligned along a longitudinal axis of the heating chamber. The power source may be aligned along a second longitudinal axis, parallel to the longitudinal axis of the heating chamber.

The charging unit may be configured for wireless charging. The charging unit may be provided with a charging port, such as a USB port, which is used to couple a power supply provided in the charging unit to an external power source for recharging.

The charging unit may comprise a control unit configured to control the transfer of power from the charging unit to the aerosol provision device when the device electrical connectors are in electrical engagement with the charge unit electrical connectors. The control unit may be configured to control the transfer of data from the charging unit to the aerosol provision device and/or from the aerosol provision device to the charging unit.

The charging unit may have a transverse cross-section of any suitable shape. For example, the charging unit may have a substantially circular, elliptical, triangular, square, rhomboidal, trapezoidal, pentagonal, hexagonal or octagonal transverse cross-section.

According to another aspect there is provided a method of generating an aerosol comprising: providing an aerosol generating system as described above; inserting an aerosol generating article into the aerosol provision device and energising the aerosol generating article.

### BRIEF DESCRIPTION OF THE DRAWINGS

Various embodiments will now be described, by way of example only, and with reference to the accompanying drawings, in which:

FIG. 1 shows a perspective view of an aerosol provision system including an aerosol provision device located within a charging unit;

FIG. 2 shows a schematic cross-sectional view of part of the aerosol provision device of FIG. 1;

FIG. 3 shows a schematic cross-sectional view of part of the aerosol provision device of FIG. 1 and an aerosol generating article of the aerosol provision system;

FIG. 4 shows a schematic cross-sectional view of an embodiment of a heater which can be used in the aerosol provision system of FIG. 1:

FIG. 5a 5b and 5c show an embodiment of an aerosol provision device and FIG. 5d shows a view of an embodiment of corresponding charging unit

FIGS. 5e and 5f show an embodiment of a component of the charging unit;

FIGS. 6a and 6b show the aerosol provision system of FIGS. 5a-e;

FIGS. 7a, 7b, 8a, 8b, 9a and 9b are schematic cross-sectional views of further embodiments of attachment mechanisms.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the non-combustible aerosol provision device may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

As used herein, the term “aerosol-generating material” is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-Generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material. The sheet may be in the form of a wrapper, it may be gathered to form a gathered sheet or it may be shredded to form a shredded sheet. The shredded sheet may comprise one or more strands or strips of aerosol-generating material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales. The article may be, for example, of a predetermined or specific size that is configured to be placed within or over a heater of the device which is sized to receive the article.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

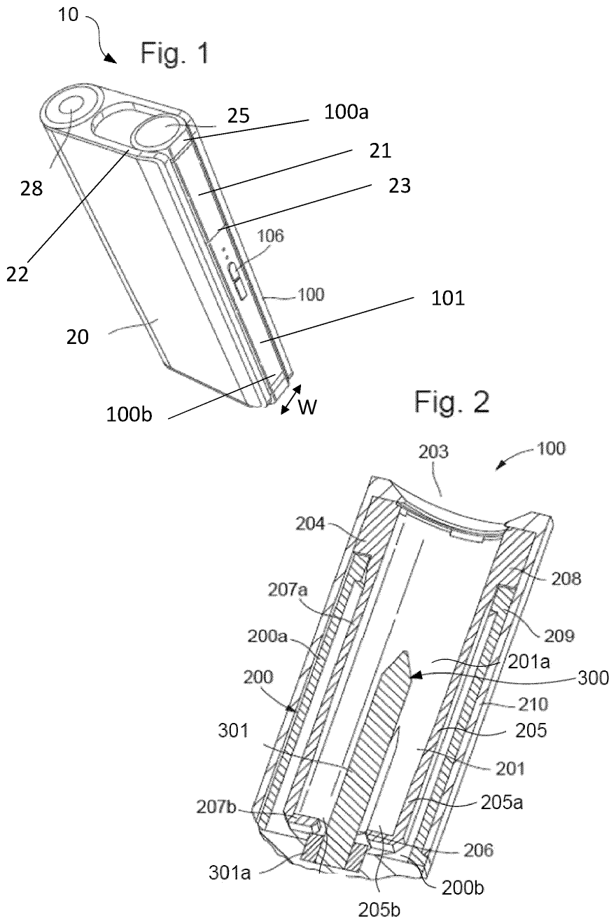

FIG. 1 shows an aerosol provision system 10 comprising an aerosol provision device 100 and a charging unit 20. The device 100 is shown located within a cavity 21 of a charging unit 20. The cavity 21 has an open end 22 (also referred to as an opening). The charging unit embodiment of FIG. 1 also comprises a longitudinal opening 23.

The aerosol provision device 100 is arranged to generate aerosol from an aerosol generating article (not shown) which may be inserted, in use, into the aerosol provision device 100. In embodiments, the article forms part of the aerosol provision system 10.

The aerosol provision device 100 is an elongate structure, extending along a longitudinal axis. The aerosol provision device 100 has a proximal end 100a, which will be closest to the user (e.g. the user's mouth) when in use by the user to inhale the aerosol generated by the aerosol provision device 100, as well as a distal end 100b which will be furthest from the user when in use. The proximal end may also be referred to as the “mouth end”. The aerosol provision device 100 also accordingly defines a proximal direction, which is directed towards the user when in use. Further, the aerosol provision device 100 also likewise defines a distal direction, which is directed away from the user when in use. The terms proximal and distal as applied to features of the device 100 will be described by reference to the relative positioning of such features with respect to each other in a proximal-distal direction along a longitudinal axis. The aerosol provision device 100 comprises an opening at the proximal end 100a, leading into a heating chamber (described below with reference to FIG. 2).

The aerosol provision device 100 may be removably inserted into the charging unit 20 in order to be charged. In the embodiment of FIG. 1, the distal end 100b of aerosol provision device 100 is inserted into the cavity 21 via the opening 22.

A portion of the aerosol provision device 100 may comprise a first side 101. One or more user-operable control elements 106, such as buttons, which can be used to operate the aerosol provision device 100 may be provided on the first side 101 of the aerosol provision device 100.

In embodiments the cavity of the charging unit 20 may have a cross-sectional profile which only permits that the aerosol provision device 100 be inserted into the charging unit 20 in a single orientation.

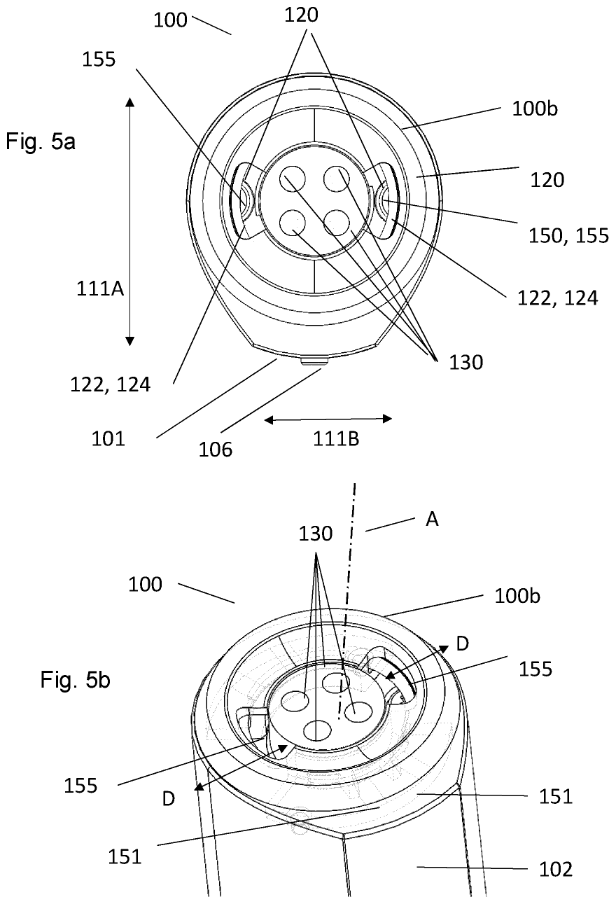

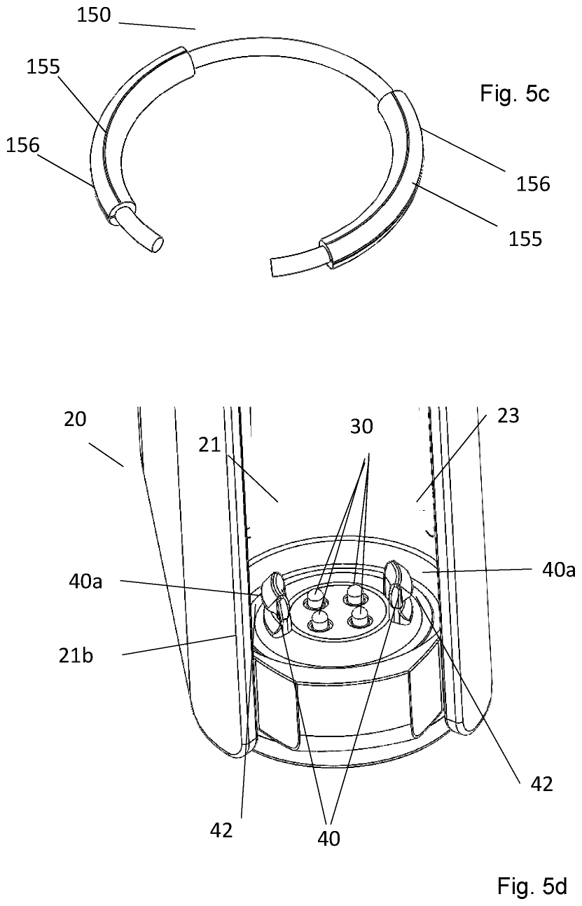

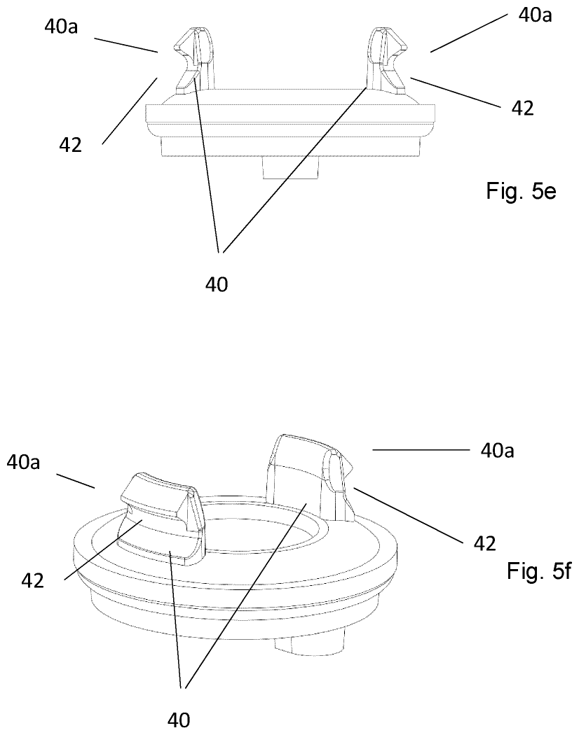

In the embodiment of FIG. 1, the outer profile of the aerosol provision device 100 comprises a first portion and a second portion (see FIG. 5a). The cross-sectional profile of the cavity 21 provided in the charging unit 20 comprises a similar first and second portion. The second portion of the cross-sectional profile of the cavity 21 correspond with the longitudinal opening 23, and the first side 101 of the device 100 aligns with and is received in the longitudinal opening 23. The first side 101 has a width W which corresponds to the width of the longitudinal opening 23 This ensures correct alignment of the device 100 in the charging unit 20. Furthermore, the user has access to the user controls 106 while the device 100 is in the charge unit 20.

In other embodiments, the aerosol provision may have an alternative shape and size, and be received in a correspondingly shaped and dimensioned cavity in the charging unit.

In other embodiments, the charge unit may include a single opening through which the device is inserted into the cavity.

The charging unit 20 includes a slidable lid 25. When the aerosol provision device 100 is inserted into the charging unit 20 in order to be recharged, the slidable lid 25 may be closed so as to cover the opening into the aerosol provision device 100.

In other embodiments, the charging unit 20 may have an alternative lid configuration, such as a hinged or pivoted lid, or no lid may be provided.

The cavity 21 of the charging unit has a length that is substantially equal to or slightly greater than the length of the aerosol provision device 100 such that substantially the entire aerosol provision device 100 is received in the cavity of the charging unit. This means that the device 100 is entirely enclosed within the cavity 21 and protected.

The charging unit 20 may include a user interface such as display 28, which can be provided at any convenient location, such as in the position shown in FIG. 1.

FIG. 2 shows a cross sectional view of a portion of the aerosol provision device 100. The aerosol provision device 100 comprises a main housing 200. The main housing 200 defines a device body of the device 100. The device 100 defines a heating chamber 201. A receptacle 205 defines the heating chamber 201. An opening 203 is provided to provide access to the heating chamber 201. The receptacle 205 comprises a wall arrangement including a receptacle side wall 205a and a receptacle base 205b. The base 205b is at the distal end of the receptacle 205. A heating zone 201a is configured at least a portion of the article for heating.

A heating arrangement 300 is provided in a portion of the main housing 200. In the embodiment shown, the heating arrangement 300 is a heater 301 which extends or projects into the heating chamber 201. The heater 301 may comprise a base portion 301a which may be located in a recess provided in a portion of the body of the device 100. The heater 301 upstands in the heating chamber 201. The heater 301 upstands from the distal end.

In the embodiment shown, the heater 301 comprises an elongate heating member in the form of a pin. The heater 301 in other embodiments comprises other elongate configurations, such as a blade.

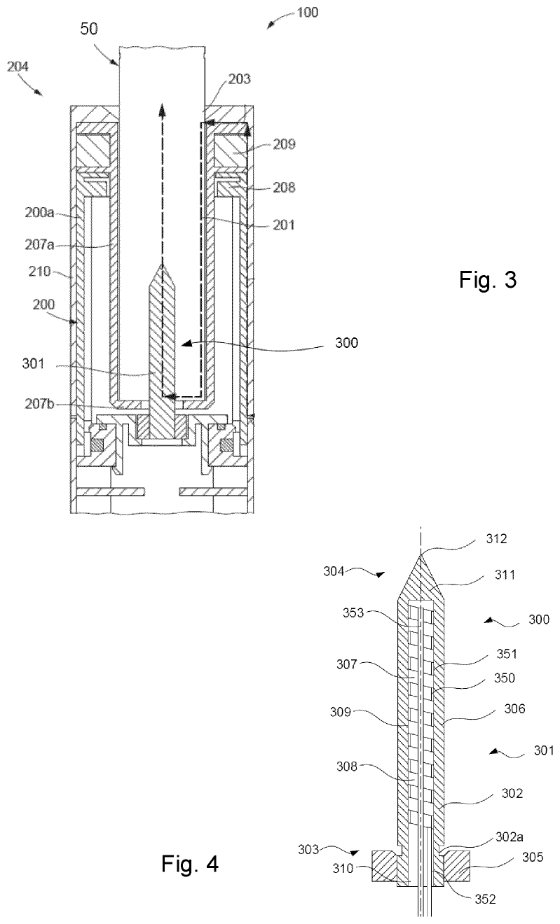

The heater 301 may be inserted, in use, into a distal end of an aerosol generating article 50 (refer to FIG. 3) which is received within the heating chamber 201 in order to internally heat the aerosol generating article.

The housing comprises housing wall 200a. The housing wall 200a extends along the longitudinal axis of the aerosol provision device 100, surrounding the heating chamber 201. The housing wall 200a may, at least in part, define a receiving chamber of the aerosol provision device 100, as the volume which is enclosed within the wall 200a. A housing base 200b is at the distal end of the housing wall 200a. In the shown embodiment, the heater 301 upstands from the housing base 200b. The heater 301 protrudes through the receptacle base 205b. An aperture 206 is formed in the receptacle base 205b through which the heater 301 protrudes. In embodiments, the heater 301 is mounted to the receptacle base 205b. The heater 301 upstands from the receptacle base 205b.

The aerosol provision device 100 further comprises a removal mechanism 204 which may be removably retained to the main housing 200 of the aerosol provision device 100. In the embodiment shown, the removal mechanism 204 defines the heating chamber 201. The removal mechanism 204 forms the receptacle 205.

In other embodiments, the removal mechanism 204 is omitted, and other features of the device 100 define the heating chamber 201, for example the housing side wall 200a and housing base 200b.

When the aerosol generating article 50 is received in the heating chamber 201, it may contact both the longitudinally extending portion of the inner surface, and the end portion of the inner surface. In particular, the article chamber (i.e. the peripheral portion 207a and the base portion 207b) may be configured to receive at least part of the aerosol generating article 50 which is in the form of rod which is longitudinally extending and cylindrical, such that the longitudinal axis of the article is parallel to (and optionally in line with) the longitudinal axis of the aerosol provision device 100 when received in the article chamber.

When the removal mechanism 204 is retained to the main housing 200, in use, the article chamber of the removal mechanism 204 is arranged, at least partially, within the heating chamber 201. The removal mechanism 204 is therefore configured to receive at least a portion of the aerosol generating article in use. In embodiments, the removal mechanism 204 may comprise a first magnet or a magnetisable material 208. The main housing 200 may comprise a second magnet or magnetisable material 209.

The removal mechanism 204 may comprise an internal element (comprising the tubular portion 207a and a base portion 207b) and an outer cap portion 210, wherein when retained to the main housing 200 the outer cap portion 210 encapsulates (e.g. covers) at least a portion of the main housing 200, such as the wall 200a of the main housing.

The heater 301 comprises an elongate heater 301 in the form of a pin. The heater 301 in other embodiments comprises other elongate configurations, such as a blade, and it will be appreciated that the heater 301 can have a variety of cross-sectional shapes.

The heater 301 is provided in the heating chamber 201. The heater 301 of FIG. 5 and the heater 301 described above with reference to FIGS. 1 to 3, such that details described herein may be applied to each. The heater 301 extends or projects into the heating chamber 201.

The heater 301 may be inserted, in use, into a distal end of the aerosol generating article 50 which is received within the heating chamber 201 in order to internally heat the aerosol generating article 50.

FIG. 4 shows an embodiment of a resistive heater 301 for use in an aerosol provision device as described above. In such arrangements the heating assembly comprises a resistive heating generator including components to heat the heating element via a resistive heating process. In this case, an electrical current is directly applied to a resistive heating element, and the resulting flow of current in the heating element, acting as a heating component, causes the heating element to be heated by Joule heating. The resistive heating element comprises resistive material configured to generate heat when a suitable electrical current passes through it, and the heating arrangement comprises electrical contacts for supplying electrical current to the resistive material. In embodiments, the heating element forms at least part of the resistive heating member itself.

In the embodiment of FIG. 4, the heater 301 comprises an elongate housing 302 and the heating element 350. The elongate housing 302 is an elongate member defining a longitudinal axis. The housing 302 is formed from a thermally conductive material, such as aluminum. Other suitable materials, such as stainless steel may be used. The elongate housing 302 may comprise a coating on its outer surface. The elongate housing 302 is configured to transfer heat from the heating element 350 to the heating zone 201a within the aerosol provision device.

The elongate housing 302 has a base end 303 and a free end 304. The base end 304 mounts to the device body. A mount 305 at the base end 303 mounts the heater 301.

The elongate housing 302 comprises a housing body 306. The housing body 306 is tubular. In other embodiments, the housing body may 306 have a variety of cross-sectional shapes, such as but not limited to, circular, elliptical, rectangular, pentagonal, hexagonal, octagonal. The housing body 306 comprises a bore 307 which defines an inner void (or cavity) 308 of the heater 301. The inner void 308 extends longitudinally.

An inner surface 309 is defined on an inner side of the elongate housing 302. An open end 310 to the inner void 308 is provided at the base end 303.

The free end 304 of the elongate housing 302 extends towards the proximal end of the heating chamber. The free end 304 of the heater 301 is closed, in other words, the inner void 308 does not extend through the free end 304. A tip 311 is provided at the free end 304. The tip 311 extends to an apex 312. Other shapes and configurations of the tip 311 may be provided, for example the tip 311 may define a planar surface.

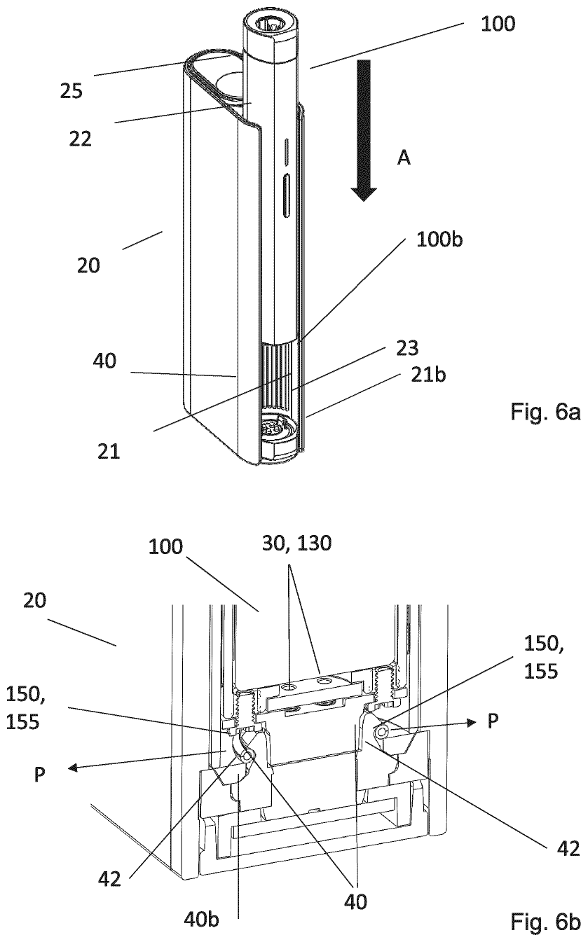

The heating element 350 is located within elongate housing 302 of the heater 301. The heating element 350 extends in the elongate housing 302 in the longitudinal direction and has a base end 350a and a free end 350b. In FIG. 6, the heating element 350 extends between the base end 303 and the free end 304. In some embodiments, the heating element extends partially along the length of the inner void 308. In some embodiments the heating element 350 extends to or beyond the open end 310.

In this embodiment, the heating coil 351 is a resistive heating coil. The heating coil 351 is a helical coil. The heating coil may have any suitable cross-sectional profile, such as a rectangular cross-sectional profile, a circular cross-sectional profile or an oval cross-sectional profile. The heating arrangement 300 comprises electrical connection paths 352, 353. The electrical connection paths extend from each end of the heating element 350.

In other embodiments, the heating arrangement 300 may comprises two or more heating coils.

FIGS. 5a to 5d show an embodiment of an attachment mechanism 11 for connecting the aerosol provision device 100 within the charging unit 20. The attachment mechanism 11 comprises a first engagement member 150 and a second engagement 40.

FIG. 5a shows a view from the distal end 100b of the aerosol provision device 100 described above. The outer profile of the aerosol provision device 100 can be seen to include the first portion 111A and the second portion 111B.

The aerosol provision device 100 comprises a base plate 120 at the distal end 100b. Two openings 122 are provided in the base plate 120. The openings 122 lead to recesses or voids 124 which extend into the distal portion 102 of the aerosol provision device 100.

In this embodiment, the first engagement member 150 is in the form of a wire spring 150. Two sections 155 of the wire spring 150 extend across radially outer edges of the openings 122.

Four electrical connectors 130 are provided for connecting the aerosol provision device 100 to the charging unit 20. At least a portion of the device electrical connectors 130 may form an electrical contact for contacting at least a portion of a corresponding electrical connectors (shown in FIG. 5c) of the one or more charging unit electrical connectors 30 in the charging unit 20.

FIG. 5b is a schematic view of the distal end 100b of the aerosol provision device 100 in which the base plate 120 is semi-transparent, such that the wire spring 150 can be seen. The spring 150 is held within the device 100 in a rest position. In the embodiment of FIG. 5b, the ends of the wire spring 151 are secured within the base plate 120. The two sections 155 of wire spring can be seen extending across the openings 122, such that when force is applied in a direction perpendicular to a longitudinal axis A of the device, each section 155 deforms in this direction from its rest position, as shown by the arrow D. The geometry of the rest of the wire spring 150 is determined by the other components in the distal end 100b of the device.

FIG. 5c shows the wire spring from FIG. 5b. The wire spring 150 is provided with two elongate covers 156 over the sections 155. The covers 156 may provide an aesthetic function. In other embodiments, no covers are provided.

FIG. 5d shows a view of a lower portion 21 of the charging unit 10 for use with the aerosol provision device 100 of FIGS. 5a and 5b.

In this embodiment, the second engagement member 40 comprises two lugs 40 which extend from a distal end 21b of the charge unit cavity 21. Each of the lugs 40 comprises a groove 42 on a radially outer surface 40a. The lugs 40 are dimensioned to fit through the openings 122 and sit within the recesses 124 when the device 100 is fully inserted into the charging unit.

Four electrical connectors 30 are provided at the distal end 23b for connecting to the aerosol provision device 100.

The charging unit 20 includes a battery pack (not shown) which can be used to charge the aerosol provision device 100 through the formed connections between the electrical connectors 30, 130.

The charging unit 20 comprises a control unit (not shown) configured to control the transfer of power from the charging unit to the aerosol provision. The control unit may also be configured to control the transfer of data from the charging unit to the aerosol provision device and/or from the aerosol provision device to the charging unit.

In this embodiment, there are two openings 122 which are kidney shaped (or bean shaped), having a radially outer surface 40a which follows a circumferential path. The two lugs 40 have corresponding profiles, and are slightly smaller than the openings to allow the lugs to fit into the voids 124.

FIGS. 5e and 5f show an embodiment of a cavity distal end plate 24 which could be used in a charging unit, such as described above. The end plate 24 forms a distal end 21b of the cavity 21. The two lugs 40 extend from the end plate 24. In other embodiments, no separate end plate is provided and the lugs are provided as integral part of the cavity end wall.

It will be appreciated that in other embodiments a different number of openings and lugs may be provided, and the opening(s) and lug(s) may be provided with any suitable shape, which will vary depending on the cross-sectional shape of the device, and configuration of internal components within the device.

The embodiment of FIGS. 5a-d comprises four electrical connectors 30, 130. However, it will be appreciated that the aerosol provision device 100 and charge unit may comprise any suitable number of electrical connectors 30, 130.

At least a portion of the one or more device electrical connectors 130 may form an electrical contact for contacting at least a portion of a corresponding electrical connectors of the one or more charging unit electrical connectors 30 in the charging unit 20. The set of electrical connectors 30, 130 together facilitate electrical power and/or data connection between the aerosol provision device 100 and the charging unit 20 when the aerosol provision device 100 is secured to the charging unit 20.

According to an embodiment, a first electrical connector may be used to transfer power from the charging unit 20 to the aerosol provision device 100, a second electrical connector may be used for grounding purposes and the remaining electrical connector(s) may be used for data transfer. For instance, there may be a single electrical contact for data transfer, or there may be two or more electrical contacts for data transfer.

According to an embodiment, the charging unit electrical connectors 30 are pogo pin connectors. As will be understood, a pogo pin connector is an electrical connector comprising an integrated spring within a pin which is configured to apply a constant normal force against the back of a mating receptacle or contact plate, which counteracts any undesirable movement which may otherwise cause an intermittent connection.

In other embodiments, the device electrical connector 130 comprises a female USB-C connector and charging unit 20 may include an electrical connector comprising a corresponding male USB-C connector. Other embodiments are contemplated wherein the aerosol provision device 100 may comprise a male USB-C connector and the charging unit 20 may comprise a female USB-C connector.

FIG. 6a shows a cross sectional view of an embodiment of the aerosol provision device 100 partially inserted into the cavity 21 of the charging unit 20 according to an embodiment. The device 100 is inserted through opening 22 and pushed in a direction P.

The device 100 is aligned with the cavity 20 such that the first side 101 sits in the longitudinal opening 23. The lugs 40 in the cavity 20 are positioned to align with the openings 122 in the device bottom plate 120.

It will be appreciated that as the device 100 is pushed towards the distal end 21b of the cavity 20, lugs 40 pass through the openings 122, with the outer surface 40a facing the wire spring 150. As the device 100 moves further, the wire spring sections 155 move past the lugs 40, they are deformed and move in a direction perpendicular to a longitudinal axis of the device, away from a contact surface 40b (or outer surface surface) of the lugs 40. In other words, the wire spring sections 155 move in a direction P that is perpendicular to a longitudinal axis of the device and away from the axis A. As the device 100 moves to its fully inserted position, the sections 155 move back to their original position and the device 100 is securely held within the cavity 20.

FIG. 6b shows a cross-sectional view of the aerosol provision system 10 with the device 100 fully inserted into the charging unit 20. The wire spring sections 155 of are engaged in the grooves 42 of the lugs 40.

To remove the device 100, the user pulls the device 100 in the opposite direction, the spring sections 155 are urged by the outer surface 40a of the lugs 40 in the direction P as they move past the lugs.

The figures on page 7 show further embodiments of attachment mechanisms for aerosol provision systems.

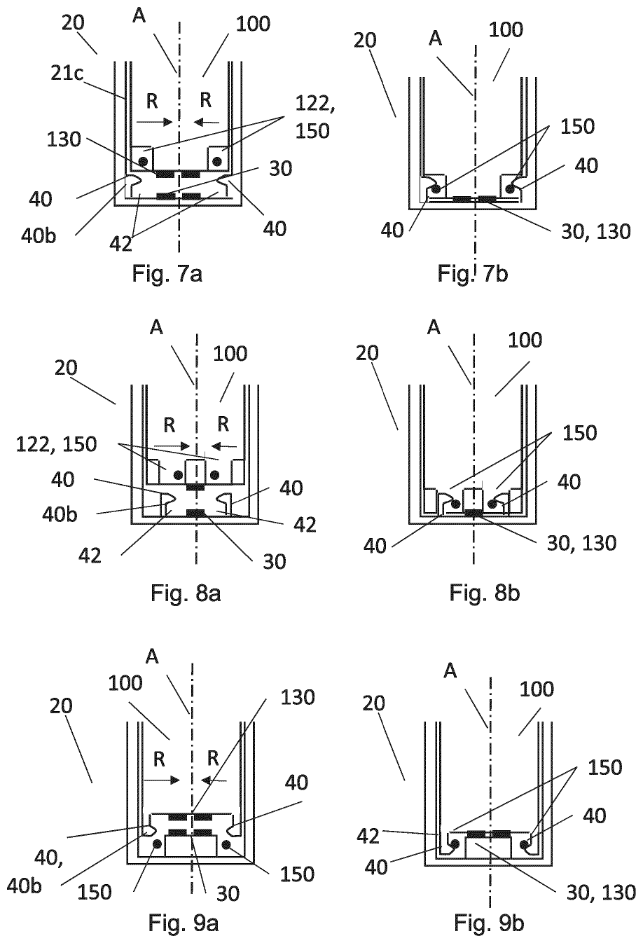

FIG. 7a shows an embodiment of an attachment mechanism 11 comprising a first engagement member 150 in the form of a wire spring 150 provided in an outer groove at the distal end 100b of the device 100. The second engagement member 40 comprises two protrusions 40 formed on an inner surface 21c of the cavity 21 of the charging unit 20. The lugs are spaced from the distal end 21b of the cavity, thereby forming two recesses 42.

Two electrical connectors 130 are provided on the device 100, and two electrical connectors 30 are provided within the cavity 21. In this embodiment, as the device 100 is pushed into the fully inserted position, the wire spring 150 is urged in a direction R, away from the contact surface 40b of the protrusion, i.e. perpendicular to a longitudinal axis of the device and towards the axis A.

FIG. 7b shows the device 100 fully inserted and secured within the charging unit 10. The wire spring 150 is positioned in the recesses 42

FIG. 8a shows an embodiment of an attachment mechanism 11 comprising a first engagement member 150 in the form of a wire spring 150 provided in the distal end 100b of the device 100. Two openings 122 leading to voids 124 are and the wire spring 150 extends across inner edges of the openings 122. The distal end 21b of the cavity is provided with a second engagement member 40 in the form of two lugs 40, each lug comprises a groove 42 on an inner surface 40b. In this embodiment, as the device 100 is pushed into the fully inserted position, the wire spring 150 is urged in a direction R, away from a contact surface 40a of the lug, i.e. perpendicular to a longitudinal axis of the device and towards the axis A. FIG. 8b shows the device 100 fully inserted and secured within the charging unit 10. The wire spring 150 is positioned in the recesses 42

FIG. 9a shows an embodiment of an attachment mechanism 11 comprising a first engagement member 150 in the form of a wire spring 150 provided in the distal end 21b of the charging unit cavity 21. The second engagement member 40 is provided on the device 10. Two lugs 40 are provided at the outer perimeter of the distal end 100b of the device. The lugs include inwardly facing recesses 42.

In this embodiment, a single electrical connector 130 is provided on the device 100, and a single electrical connector 30 is provided within the cavity 21. This could represent a USB electrical connection.

As the device 100 is pushed into the fully inserted position, the wire spring 150 is urged in a direction R, away from a contact surface 40b of the lug, i.e. perpendicular to a longitudinal axis of the device and towards the axis A. FIG. 9b shows the device 100 fully inserted and secured within the charging unit 10. The wire spring 150 is positioned in the recesses 42

In the embodiments above the second engagement member comprises two lugs. In other embodiments, the second engagement member may comprise one or more lugs. The second engagement member may comprise one single lug, the single lug may have one or more grooves or recesses. The second engagement may comprise one, three or four lugs

In the embodiments above, the first engagement member comprises a single wire spring. In further embodiments, the first engagement member may comprise two or more wire springs.

In another embodiment (not shown), the device is provided with one or more lugs

The first and second engagement members 40, 150 may act to ensure alignment of the charge unit electrical connectors 30 and the device electrical connectors 130 when the device is inserted into the charge unit.

FIG. 9a shows an embodiment of an attachment mechanism 11 comprising a first engagement member 150 in the form of a wire spring 150 provided in the distal end 21b of the charging unit cavity 21.

In embodiments, the cavity 21 of the charging unit 20 and the aerosol provision device 100 may comprise corresponding grooves e.g. grooves on the internal surface of the cavity and grooves on the outer surface 107 of the aerosol provision device 100 to further ensure self-guiding occurs.

It has been found that the attachment mechanism according to embodiments described above ensures that the aerosol provision device is secured within the cavity of the charging unit in a relatively secure and low-cost manner.

The attachment mechanism according to embodiments is compact and takes up a relatively small volume within the aerosol provision device.

Further, when a user inserts the aerosol provision device into the charging unit cavity in accordance with embodiments of the invention, the user receives tactile and audible indication of engagement, to provide confidence to the user that the aerosol provision device is securely held within the cavity.

In the above described embodiments, the heating arrangement is a resistive heating arrangement. In embodiments, other types of heating arrangement are used, such as inductive heating. The configuration of the device is generally as described above and so a detailed description will be omitted.

An inductive heating arrangement comprises various components to heat the aerosol generating material of the article via an inductive heating process. Induction heating is a process of heating an electrically conducting heating member (such as a susceptor) by electromagnetic induction. An induction heating arrangement may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating member) suitably positioned with respect to the inductive element. In inductive heating, as compared to heating by conduction for example, heat is generated inside the susceptor, allowing for rapid heating. Further, there need not be any physical contact between the inductive element and the susceptor, allowing for enhanced freedom in construction and application.

In inductive heating heat is generated in the susceptor (heating member) whereas in resistive heating heat is generated in the coil (heating element).

In embodiments, the heating member of the aerosol provision system is a part of the aerosol generating article, rather than being a part of the aerosol provision device. The heating element may be a resistive heating element, for example in the form of the resistive coil described above, which is provided as part of the aerosol generating article. Electrical connections may enable electric current to flow through the resistive heating element.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision system comprising:
an aerosol provision device; and
a charging unit for charging or powering the aerosol provision device, the charging unit having a cavity for receiving the aerosol provision device;
the aerosol provision device and the charging unit being connectable by an attachment mechanism,
the attachment mechanism comprising:
a first engagement member comprising at least one wire spring; and
a second engagement member;
wherein the aerosol provision device comprises one of the first and second engagement members, and the charging unit comprises the other of the first and second engagement members; and
wherein the first engagement member is configured to snap into engagement with the second engagement member when the aerosol provision device is inserted into the cavity, and disengage with the second engagement member when the device is pulled out of the cavity, enabled by movement of the first engagement member in a direction perpendicular to a longitudinal axis of the aerosol provision device.

2. The aerosol provision system according to claim 1, wherein the first engagement member is provided on the charging unit and the second engagement member is provided on the aerosol provision device.

3. The aerosol provision system according to claim 1, wherein the first engagement member is provided on the aerosol provision device and the second engagement member is provided on the charging unit.

4. The aerosol provision system according to claim 1, wherein the second engagement member comprises one or more grooves or recesses.

5. The aerosol provision system according to claim 1, wherein the first engagement member comprises a single wire spring and the second engagement member comprises two or more grooves or recesses.

6. The aerosol provision system according to claim 1, wherein the first engagement member comprises two or more wire springs and the second engagement member comprises corresponding grooves or recesses.

7. The aerosol provision system according to claim 1, wherein the charging unit comprises one or more lugs at a distal end of the cavity, and the aerosol provision device comprises one or more corresponding accommodating recesses for receiving the one or more lugs when the aerosol provision device is received in the cavity.

8. The aerosol provision system according to claim 7, wherein the second engagement member is provided on the one or more lugs.

9. The aerosol provision system according to claim 1, wherein the first engagement member is configured to snap into engagement with the second engagement member by moving in a direction towards a central axis of the cavity.

10. The aerosol provision system according to claim 1, wherein the first engagement member is configured to snap into engagement with the second engagement member by moving in a direction away from a central axis of the cavity.

11. The aerosol provision system according to claim 1, wherein the aerosol provision device further comprises one or more first electrical connectors for connecting to the charging unit, and the charging unit comprises one or more second electrical connectors.

12. The aerosol provision system according to claim 11, wherein the one or more first electrical connectors are provided at a distal end of the aerosol provision device.

13. The aerosol provision system according to claim 1, wherein the cavity of the charging unit has a cross-sectional profile which corresponds to a profile of the aerosol provision device.

14. The aerosol provision system as claimed in claim 1, further comprising an aerosol generating article.

15. A method of generating an aerosol comprising:
providing aerosol provision system as claimed in claim 1;
inserting an aerosol generating article into the aerosol provision device and energising the aerosol generating article.
